(19) United States
(12) Patent Application Publication
(10) Pub. No.: US 2007/0187537 A1
(43) Pub. Date: Aug. 16, 2007

(54) Repairing crusher rolls

(75) Inventor: Robin John Batterham, Victoria (AU)

Correspondence Address: OBLON, SPIVAK, MCCLELLAND, MAIER & NEUSTADT, P.C., 1940 DUKE STREET, ALEXANDRIA, VA, 22314, US

(73) Assignee: TECHNOLOGICAL RESOURCES PTY LIMITED, Melbourne (AU)

(21) Appl. No.: 10/564,194

(22) PCT Filed: Jul. 9, 2004
(86) PCT No.: PCT/AU04/00935

§ 371 Date: Jul. 24, 2006

(30) Foreign Application Priority Data
Jul. 11, 2003 (AU) 2003903620

(51) Int. Cl. B02C 4/30

(52) U.S. Cl. 241/235; 241/300

(57) ABSTRACT

A roll crusher assembly for use in the mining industry is disclosed. The assembly includes one or more than one roll (3) for crushing a feed material. The roll or rolls has an outer surface that is formed from a wear resistant material. The assembly also includes a means, such as a welding assembly (13), for depositing a hard facing material onto the surface of the roll or rolls as the roll or rolls rotate during a crushing operation.

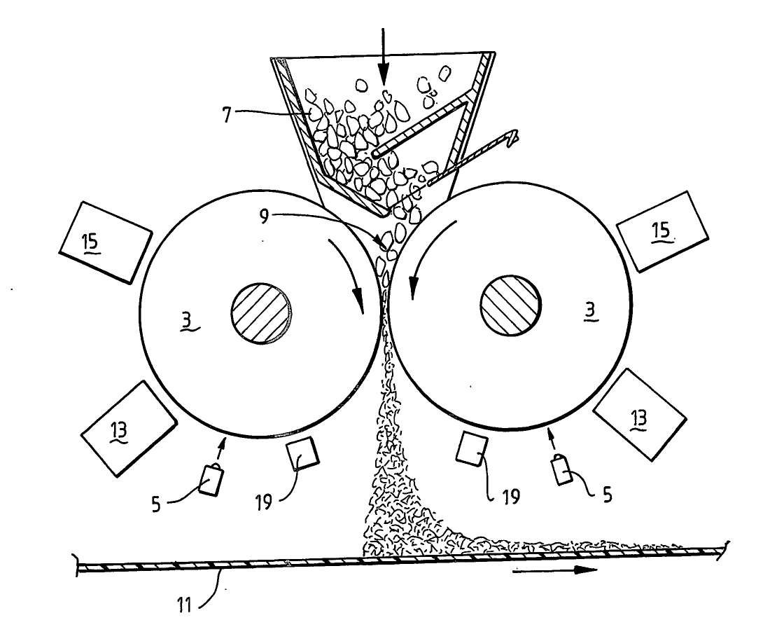

### REPAIRING CRUSHER ROLLS

The present invention relates to roll crushers used in the mining industry.

Roll crushers are generally used as secondary crushers for crushing ore particles that are less than 15 cm.

A major limitation on the use of high pressure grinding rolls of new generation roll crushers is the wear encountered when the rolls are used to crush hard materials. However, these machines have significant advantages in their higher energy efficiencies when crushing fine products in comparison to other comminution devices.

Roll crushers are suited particularly to crushing materials such as limestone, coal, chalk, gypsum, phosphate, diamond ores, and soft iron ores. The use of roll crushers in the mining industry is not confined to these materials but is still limited with harder materials, except where roll crushers have specific advantages such as in the case of their use for diamond ores.

A standard roll crusher has two contra-rotated horizontal cylindrical rolls. The contra-rotating rolls promote movement of feed material supplied from above the rolls downwardly through the nip region of the rolls, with the result that the material is crushed by the pressure applied to the material by the rolls in the nip region.

Typically, one roll of the two contra-rotating rolls is fixed and the other roll is mounted for lateral movement relative to the fixed roll and is spring-biased to apply a constant crushing pressure to material in the nip region between the rolls.

Roll crushers are also manufactured with only one rotating roll. In these roll crushers, the rotating roll cooperates with a fixed plate positioned a predetermined distance from the roll.

Other known roll crushers use 3, 4 or 6 rolls arranged appropriately.

Roll crushers used in the mining industry are subject to high wear. Typically, the rolls are made from cast iron and have a hard facing of a suitable material, such as tungsten carbide, to minimise wear and maximise roll life. However, generally, roll wear is inevitable.

The current practice for dealing with roll wear is to take a roll crusher out of service and replace the worn rolls with replacement rolls and re-start the roll crusher and thereafter repair the worn rolls off-line.

The major disadvantage of this practice is the loss of throughput caused by the down-time of the roll crusher to change-over the rolls. The down-time for roll change-over can be a significant period given the large size of crusher rolls that are generally used in the mining industry and the issues, such as alignment of the replacement rolls, that have to be addressed in order to re-start operation of a roll crusher with replacement rolls.

An object of the present invention is to provide a roll crusher that is not subject to the above-described disadvantages of the current practice for dealing with roll wear.

Another object of the present invention is to provide a method of repairing a roll or rolls of a roll crusher that is not subject to the above-described disadvantages of the current practice for dealing with roll wear.

According to the present invention there is provided a roll crusher assembly for use in the mining industry that includes:
(a) one or more than one roll for crushing a feed material, the roll or rolls having an outer surface that is formed from a wear resistant material; and
(b) a means, such as a welding assembly, for depositing a hard facing material onto the surface of the roll or rolls as the roll or rolls rotate during a crushing operation.

The above-described hard facing deposition means makes it possible to repair the roll or rolls of the roll crusher assembly during a crushing operation.

The term “hard facing material” is understood herein to mean a hard, wear resistant material that can be deposited onto the surface of a metal component, such as a roll, that is subject to wear in order to reduce wear of the component by abrasion, impact, or erosion.

Options for depositing hard facing materials include, by way of example, means for welding and spraying hard facing materials.

Hard facing materials include, by way of example, (a) iron-based alloys containing one or more of the following alloying elements; chromium, manganese, silicon, tungsten, molybdenum, nickel, and vanadium; (b) alloys based on one or more of chromium, nickel, cobalt and tungsten; and (c) composite materials containing particles of hard materials, such as tungsten carbide particles, dispersed in a continuous matrix.

Preferably the hard facing deposition means includes a welding assembly that is positioned in relation to the roll or rolls to deposit the hard facing material onto the surface of the roll or rolls as the roll or rolls rotate during the crushing operation.

Preferably the welding assembly is an arc welding assembly.

In situ repair of the roll or rolls by means of a welding assembly as the roll crusher operates is feasible because the rolls of roll crushers that are used in the mining industry are usually large-size rolls (and therefore are a substantial heat sink) and rotate relatively slowly. Accordingly, welding can be completed before the repaired sections of the roll or rolls rotate to the roll crushing region of the roll crusher assembly, ie the nip region of the rolls in the case of a roll crusher assembly that includes two contra-rotating rolls.

Typically the roll or rolls are of the order of 1-3 m in diameter.

Typically, in a situation in which the roll crusher assembly includes a pair of contra-rotating rolls, the rolls include a system for operating the rolls that is adapted to allow some movement of one roll such that the gap between the rolls can be varied and therefore absolute precision is not necessary in respect of the thicknesses of the hard facing coatings on the surfaces of the rolls and the main requirement therefore is that all of the roll surfaces that require protection be protected by the hard facing material and that there is not an excessive build up of material over time.

Preferably the roll crusher assembly includes two contra-rotating rolls.

The hard facing deposition means may be operable to deposit a continuous layer of the hard facing material onto the surface of the roll or rolls.

Alternatively, the hard facing deposition means may be operable to deposit the hard facing material onto the surface of the roll or rolls only on those sections of the roll or rolls that have become worn to the extent that repair is necessary.

Preferably the roll crusher assembly includes a means for monitoring the surface of the roll or rolls.

Preferably the roll surface monitoring means is adapted to determine the extent of wear on the surface of the roll or rolls.

The roll surface monitoring means may be any suitable means, such as an optical means, for determining the extent of wear on the surface of the roll or rolls and identifying worn sections of the roll or rolls.

One roll surface monitoring means that is currently favoured is a laser optical continuous monitoring means that includes a laser system mounted on a specially designed frame arranged to minimise vibrations which, if uncontrolled, could prevent accurate measurement. One possible system is the type used for gravity gradiometer units in airborne mineral exploration. Another possible system is the type used to stabilise projector systems such as used in IMAX theatres.

Preferably the hard facing deposition means includes a means that is responsive to the roll surface monitoring means and can actuate the hard facing deposition means to deposit the hard facing material onto the worn sections of the roll or rolls.

Preferably the roll crusher assembly includes a means for cleaning the surface of the rotating roll or rolls upstream of the hard facing deposition means in the direction of rotation of the roll or rolls.

The cleaning means may be any suitable means, such as brushes or scrapers that are supported to contact the roll or rolls.

Preferably the roll crusher assembly includes a means for heat treating the deposited hard facing material on the rotating roll or rolls downstream of the hard facing deposition means in the direction of rotation of the roll or rolls.

The heat treatment means is required to increase the toughness of the hard facing materials that tend to form brittle deposits on the rolls.

According to the present invention there is also provided a method of repairing a roll or rolls of a roll crusher assembly for use in the mining industry that includes depositing a hard facing material onto the surface of the roll or rolls as the roll or rolls rotate during a crushing operation.

Preferably the method further includes monitoring the surface of the roll or rolls and determining the extent of wear on the surface of the roll or rolls and identifying worn sections of the roll or rolls and depositing the hard facing material onto worn roll sections.

The present invention is described further by way of example with reference to the accompanying drawing that is a side view of an embodiment of a roll crusher assembly for use in the mining industry in accordance with the present invention.

The roll crusher assembly shown in the figure includes a pair of contra-rotating rolls 3, with one roll fixed and the other roll supported for lateral movement and spring-biased by a means (not shown) to apply a constant pressure to material supplied downwardly via the hopper 7 to the nip region 9 of the rolls.

In use, rotation of the rolls in opposite directions draws material supplied via the hopper 7 downwardly through the nip region 9 and the material is crushed by the pressure applied by the rolls 3 as it moves through the nip region 9.

The crushed material passes downwardly from the nip region 9 onto a conveyor 11 and is transferred by the conveyor for further processing—as required by a given mining operation.

The roll crusher assembly also includes assemblies 19 for cleaning the surfaces of the rolls 3. The cleaning assemblies 19 are positioned immediately downstream of the nip region 9 in the direction of rotation of the rolls. Suitable cleaning assemblies include brushes and scrapers (not shown) that are supported to contact the rolls 3.

The roll crusher assembly also includes a roll monitoring means in the form of optical detection systems 5 positioned downstream of the cleaning assemblies 19 for monitoring the surfaces of the rolls 3 and for determining whether the rolls 3 are worn to an extent that the rolls require repair. The optical detection systems may be any suitable system for detecting the full width the rolls 3, such as a laser system (not shown) mounted on a specially designed frame arranged to minimise vibrations.

The roll crusher assembly also includes hard fading deposition means in the form of arc welding assemblies 13 positioned downstream of the optical detection systems 5 for depositing layers of hard facing material onto the surfaces of the rolls to repair the rolls 3 as the rolls rotate back to the nip region 9.

The welding assemblies 13 are responsive to the optical detection systems 5 and operate to deposit the hard facing material on the sections of the rolls that are determined to be worn to an extent that repair is warranted.

The welding assembly 13 for each roll 3 includes an arc welding head (not shown) that carries an electrode and a carriage (not shown) that supports the head for movement across the width and along an arc of the circumference of the roll 3 to deposit hard facing material onto the worn sections of the roll 3.

Typically, the hard facing material is an alloy that tends to form a brittle deposit on the surfaces of the rolls 3.

Accordingly, the roll crusher assembly also includes heat treatment stations 15 positioned downstream of the welding assemblies 13 for heat treating the deposited hard facing material on the rolls 3 to increase the toughness of the deposited material. The heat treatment station 15 for each roll 3 includes a heated torch that is supported for movement across the width and along an arc of the circumference of the roll 3 to selectively heat treat the deposited hard facing material.

Many modifications may be made to the embodiment of the resent invention described above without departing from the spirit and scope of the invention.

1. A roll crusher assembly for use in the mining industry that includes:
(a) one or more than one roll for crushing a feed material, the roll or rolls having an outer surface that is formed from a wear resistant material; and
(b) a means for depositing a hard facing material onto the surface of the roll or rolls as the roll or rolls rotate during a crushing operation.

2. The roll crusher assembly defined in claim 1 wherein the hard facing material includes any one of (a) iron-based alloys containing one or more of the following alloying elements chromium, manganese, silicon, tungsten, molybdenum, nickel, and vanadium; (b) alloys based on one or more of chromium, nickel, cobalt and tungsten; and (c) composite materials containing particles of hard materials dispersed in a continuous matrix.

3. The roll crusher assembly defined in claim 1 or claim 2 wherein the hard facing deposition means includes a welding means.

4. The roll crusher assembly defined in claim 1 or claim 2 wherein the hard facing deposition means includes a welding means that is positioned in relation to the roll or rolls to deposit the hard facing material onto the surface of the roll or rolls as the roll or rolls rotate during the crushing operation.

5. The roll crusher assembly defined in claim 3 wherein the welding means is an arc welding assembly.

6. The roll crusher assembly defined in claim 1 wherein the hard facing deposition means is operable to deposit a continuous layer of the hard facing material onto the surface of the roll or rolls.

7. The roll crusher assembly defined in claim 1 wherein the hard facing deposition means is operable to deposit the hard facing material onto the surface of the roll or rolls only on those sections of the roll or rolls that have become worn to the extent that repair is necessary.

8. The roll crusher assembly defined in claim 1 wherein the roll or rolls are of the order of 1-3 m in diameter.

9. The roll crusher assembly defined in claim 1 includes a pair of contra-rotating rolls that have a gap therebetween and a means for varying the gap whereby absolute precision is not necessary in respect of the thickness of the hard facing material on the surfaces of the rolls and the main requirement is that all of the roll surfaces that require protection be protected by the hard facing material and there is not an excessive build up of material over time.

10. The roll crusher assembly defined in claim 1 includes a means for monitoring the surface of the roll or rolls.

11. The roll crusher assembly defined in claim 10 wherein the roll surface monitoring means is adapted to determine the extent of wear on the surface of the roll or rolls.

12. The roll crusher assembly defined in claim 10 or claim 11 wherein the roll surface monitoring means is an optical means.

13. The roll crusher assembly defined in claim 10 or claim 11 wherein the roll surface monitoring means is a laser optical continuous monitoring means that includes a laser system mounted on a frame arranged to minimise vibrations.

14. The roll crusher assembly defined in claim 10 wherein the hard facing deposition means includes a means that is responsive to the roll surface monitoring means and can actuate the hard facing deposition means to deposit the hard facing material onto the worn sections of the roll or rolls.

15. The roll crusher assembly defined in claim 1 includes a means for cleaning the surface of the rotating roll or rolls upstream of the hard facing deposition means in the direction of rotation of the roll or rolls.

16. The roll crusher assembly defined in claim 1 includes a means for heat treating the deposited hard facing material on the rotating roll or rolls downstream of the hard facing deposition means in the direction of rotation of the roll or rolls.

17. A method of repairing a roll or rolls of a roll crusher assembly for use in the mining industry that includes depositing a hard facing material onto the surface of the roll or rolls as the roll or rolls rotate during a crushing operation.

18. The method defined in claim 17 includes monitoring the surface of the roll or rolls and determining the extent of wear on the surface of the roll or rolls and identifying worn sections of the roll or rolls and depositing the hard facing material onto worn roll sections.

19. A roll crusher assembly for use in the mining industry that includes:
(a) one or more than one roll for crushing a feed material, the roll or rolls having an outer surface that is formed from a wear resistant material;
(b) a means for depositing a hard facing material onto the surface of the roll or rolls as the roll or rolls rotate during a crushing operation; and
(c) a means for monitoring the surface of the roll or rolls wherein the roll surface monitoring means including a laser optical continuous monitoring means that includes a laser system mounted on a frame arranged to minimise vibrations.

20. A roll crusher assembly for use in the mining industry that includes:
(a) one or more than one roll for crushing a feed material, the roll or rolls having an outer surface that is formed from a wear resistant material;
(b) a means for depositing a hard facing material onto the surface of the roll or rolls as the roll or rolls rotate during a crushing operation; and
(c) a means for heat treating the deposited hard facing material on the rotating roll or rolls downstream of the hard facing deposition means in the direction of rotation of the roll or rolls.
